(19) United States
(12) Patent Application Publication
(10) Pub. No.: US 2003/0158286 A1
(43) Pub. Date: Aug. 21, 2003

(54) Active energy beam-curable composition

(75) Inventors: Masahiro Nishizaki, Iwakura-shi (JP); Minobu Maeda, Konan-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/351,485

(22) Filed: Jan. 27, 2003

(30) Foreign Application Priority Data
Jan. 28, 2002 (JP) 2002-018383

(51) Int. Cl. C08G 2/00

(52) U.S. Cl. 522/168

(57) ABSTRACT

An active energy beam-curable composition comprises an epoxy compound, an oxetane compound, a photo-cationic polymerization initiator, a pigment as a coloring agent, and a pigment dispersing agent. The pigment dispersing agent contains an active ingredient of a comb-shaped polymer in which an anchor is a base and which is liquid at room temperature. Therefore, the adhesion performance is satisfactory even on a base material such as polycarbonate on which it has been impossible to obtain any satisfactory adhesion performance with any conventional active energy beam-curable composition.

### BACKGROUND OF THE INVENTION

1. Field of the Invention

The present invention belongs to a technical field in relation to the active energy beam-curable composition.

2. Related Art

A composition, which cures when irradiated with an active energy beam such as ultraviolet light and electron beam, is known. Such a composition is widely used, for example, for the way of use of the coating and the printing.

When such a composition is used for the coating, for example, it is required that the composition is excellent in adhesion performance on a base material (for example, a synthetic resin). However, the substance, which is to be used as the base material, includes those exemplified by polycarbonate on which a cured coating film hardly adheres.

When the composition is practically used, the curing reaction of a cured coating film is advanced to generate the out-gas in some cases. However, the out-gas causes the odor and the cloudiness due to the adhesion of the out-gas to miscellaneous portions. Therefore, it has been demanded that the amount of generation of the out-gas is made extremely small (ideally zero) depending on the way of use.

### SUMMARY OF THE INVENTION

An object of the present invention is to provide an active energy beam-curable composition which has satisfactory adhesion performance even on a base material such as polycarbonate. Especially, an object of the present invention is to provide an active energy beam-curable composition which has satisfactory adhesion performance and which scarcely generates the out-gas as well.

According to the present invention, there is provided an active energy beam-curable composition comprising an epoxy compound (A), an oxetane compound (B), a photo-cationic polymerization initiator (C), a pigment (D) as a coloring agent, and a pigment dispersing agent (E), wherein:

the pigment dispersing agent (E) contains, as an active ingredient, a comb-shaped polymer in which an anchor is a base and which is liquid at room temperature. The term “anchor” means herein a portion including a functional group which bonds or connects to a pigment. Although there are many types of pigment dispersing agent of which anchors are acid, base, nonion, anion, cation etc., a pigment dispersing agent used in the invention has a base anchor.

In the active energy beam-curable composition of the present invention, the pigment dispersing agent (E) may have a composition in which the active ingredient is 100%. Namely, the pigment active ingredient consists of the comb-shaped polymer.

In the active energy beam-curable composition of the present invention, the comb-shaped polymer, in which the anchor is the base and which is liquid at room temperature, may be a graft polymer.

In the active energy beam-curable composition of the present invention, the graft polymer may be a graft polymer of poly(ethyleneimine)-poly(1,2-hydroxystearic acid). In the graft polymer, the anchor is poly(ethyleneimine) portion: (CH₂CH₂NH)ₙ.

In the active energy beam-curable composition of the present invention, the epoxy compound (A) may be blended in an amount of 5 to 95 parts by weight, the oxetane compound (B) may be blended in an amount of 5 to 95 parts by weight, the photo-cationic polymerization initiator (C) may be blended in an amount of 0.5 to 12 parts by weight, and the pigment dispersing agent (E) may be blended in an amount of not more than 20 parts by weight, provided that a total amount of the epoxy compound (A) and the oxetane compound (B) is 100 parts by weight.

In the active energy beam-curable composition of the present invention, the pigment dispersing agent (E) may be blended such that a weight ratio of the pigment dispersing agent (E) to the pigment (D) is not more than 2.

### DESCRIPTION OF THE PREFERRED EMBODIMENTS

Those exemplified below can be used as the epoxy compound to be used for the active energy beam-curable composition of the present invention. Further, any epoxy compound, which is used for the known active energy beam-curable composition, can be used without any problem.

### EXAMPLES OF THE EPOXY COMPOUND

Diglycidyl ethers such as bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, bis(3,4-epoxycyclohexylmethy) adipate, vinylcyclohexene oxide, 4-vinylepoxycyclohexane, bis(3,4-epoxy-6-methylcyclohexylmethyl) adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl) ether of ethylene glycol, ethylenebis(3,4-epoxychclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, and polypropylene glycol diglycidyl ether; polyglycidyl ethers of polyether polyol obtained by adding one or more alkylene oxide or alkylene oxides to aliphatic polyvalent alcohol such as ethylene glycol, propylene glycol, and glycerol; diglycidyl esters of aliphatic long chain dibasic acid; monoglycidyl ethers of aliphatic higher alcohols; monoglycidyl ethers of phenol, cresol, butylphenol, or polyether alcohol obtained by adding alkylene oxide to phenol, cresol, or butylphenol; glycidyl esters of higher fatty acids; epoxydated soybean oil, butyl epoxystearate, octyl epoxystearate, epoxydated linseed oil, epoxydated polybutadiene, and so forth.

The oxetane compound, which is used for the active energy beam-curable composition of the present invention, is the compound having one or more oxetane ring or oxetane rings represented by the following chemical formula (1):

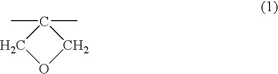

The compound causes the polymerization reaction and/or the crosslinking reaction by being irradiated with the active energy beam in the presence of the photocation polymerization initiator.

### EXAMPLES OF THE OXETANE COMPOUND

The following compounds are exemplified as the oxetane compound having one oxetane ring.

3-Ethyl-3-hydroxymethyloxetane, 3-(meth)allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl) ether, isobornyloxyethyl(3-ethyl-3-oxetanylmethyl) ether, isobornyl(3-ethyl-3-oxetanylmethyl) ether, 2-ethylhexyl(3-ethyl-3-oxetanylmethyl) ether, ethyl diethylene glycol (3-ethyl-3-oxetanylmethyl) ether, dicyclopentadiene (3-ethyl-3-oxetanylmethyl) ether, dicyclopentenyloxyethyl (3-ethyl-3-oxetanylmethyl) ether, dicyclopentenyl (3-ethyl-3-oxetanylmethyl) ether, tetrahydrofurfuryl (3-ethyl-3-oxetanylmethyl) ether, tetrabromophenyl (3-ethyl-3-oxetanylmethyl) ether, 2-tetrabromophenoxyethyl (3-ethyl-3-oxetanylmethyl) ether, tribromophenyl (3-ethyl-3-oxetanylmethyl) ether, 2-tribromophenoxyethyl (3-ethyl-3-oxetanylmethyl) ether, 2-hydroxyethyl (3-ethyl-3-oxetanylmethyl) ether, 2-hydroxypropyl (3-ethyl-3-oxetanylmethyl) ether, butoxyethyl (3-ethyl-3-oxetanylmethyl) ether, pentachlorophenyl (3-ethyl-3-oxetanylmethyl) ether, pentabromophenyl (3-ethyl-3-oxetanylmethyl) ether, bornyl (3-ethyl-3-oxetanylmethyl) ether, and so forth.

The following compounds are exemplified as the oxetane compound having two or more oxetane rings.

3,7-Bis(3-oxetanyl)-5-oxa-nonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether, dicyclopentenyl bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, tricyclodecanediyldimethylene (3-ethyl-3-oxetanylmethyl) ether, trimethylolpropane tris(3-ethyl-3-oxetanylmethyl) ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl) ether, pentaerythritol tetrakis(3-ethyl-3-oxetanylmethyl) ether, polyethylene glycol bis(3-ethyl-3-oxetanylmethyl) ether, dipentaerythritol hexakis(3-ethyl-3-oxetanylmethyl) ether, dipentaerythritol pentakis(3-ethyl-3-oxetanylmethyl) ether, dipentaerythritol tetrakis(3-ethyl-3-oxetanylmethyl) ether, caprolactone modified dipentaerythritol hexakis(3-ethyl-3-oxetanylmethyl) ether, caprolactone modified dipentaerythritol pentakis(3-ethyl-3-oxetanylmethyl) ether, ditrimethylolpropane tetrakis(3-ethyl-3-oxetanylmethyl) ether, EO modified bisphenol A bis(3-ethyl-3-oxetanylmethyl) ether, PO modified bisphenol A bis(3-ethyl-3-oxetanylmethyl) ether, EO modified hydrogenated bisphenol A bis(3-ethyl-3-oxetanylmethyl) ether, PO modified hydrogenated bisphenol A bis(3-ethyl-3-oxetanylmethyl) ether, EO modified bisphenol F (3-ethyl-3-oxetanylmethyl) ether, and so forth. The oxetane compounds are disclosed in U.S. Pat. No. 5,463,084, a content of which has been herein incorporated by reference.

In particular, the oxetane compound, which can be used especially preferably, includes, 3-ethyl-3-hydroxymethyloxetane, 1,4-bis{[(3-ethyl-3-oxetanyl)methoxy]methyl}benzene, 3-ethyl-3-(phenoxymethyl)oxetane, di[1-ethyl(3-oxetanyl)]methyl ether, 3-ethyl-3-(2-ethylhexyloxymethyl)oxetane, 3-ethyl-3-{[3-(triethoxysilyl)propoxy]methyl}oxetane, oxetanyl silsesquioxane, and phenol novolac oxetane.

One of the oxetane compounds can be used singly, or two or more of the oxetane compounds can be used in combination.

The photo-cationic polymerization initiator, which constitutes the resin composition of the present invention, is the compound to start the cationic polymerization of the epoxy compound and the oxetane compound by receiving the energy beam such as the ultraviolet light and the electron beam.

An onium salt, which has a structure represented by the following formula (2), may be exemplified as a preferred example of the photo-cationic polymerization initiator. The onium salt is a compound which liberates Lewis acid by receiving the light.

[R¹²aR¹³bR¹⁴cR¹⁵dW]^{+m}[MXn+m]^{-m} (2)

In the formula, the cation is the onium ion, W is S, Se, Te, P, As, Sb, Bi, O, I, Br, Cl, or N≡N, R12, R13, R14, and R15 are an identical organic group or different organic groups, and a, b, c, and d are integers of 0 to 3 respectively, in which (a+b+c+d) is equal to the valency number of W. M is a metal or a metalloid for constituting the central atom of the halide complex [MXn+m], and M is, for example, B, P, As, Sb, Fe, Sn, Bi, Al, Ca, In, Ti, Zn, Sc, V, Cr, Mn, or Co. X is, for example, a halogen atom such as F, Cl, and Br, m is the net charge of the halide complex ion, and n is the valence of M.

In the formula (2), the onium ion is specifically exemplified, for example, by diphenyliodonium, 4-methoxydiphenyliodonium, bis(4-methylphenyl)iodonium, bis(4-tert-butylphenyl)iodonium, bis(dodecylphenyl)iodonium, triphenylsulfonium, diphenyl-4-thiophenoxyphenylsulfonium, bis[4-(diphenylsulfonio)-phenyl]sulfide, bis[4-(di(4-(2-hydroxyethyl)phenyl)sulfonio)-phenyl]sulfide, and η5-2,4-(cyclopentadienyl)[1,2,3,4,5,6-η)-(methylethyl)-benzene]-iron(1+).

The anion (MXn+m) in the formula (2) is specifically exemplified, for example, by tetrafluoroborate (BF₄⁻), hexafluorophosphate (PF₆⁻), hexafluoroantimonate (SbF₆⁻), hexafluoroarsenate (AsF₆⁻), and hexachloroantimonate (SbCl₆⁻).

The onium salt, which can be used as the photo-cationic polymerization initiator, includes onium salts having other anions such as anion represented by a general formula [MXn(OH)—] (wherein M, X, and n are as defined in the formula (2)) in place of [MXn+m] in the general formula (2), perchloric acid ion (ClO₄⁻), trifluoromethanesulfonic acid ion (CF₃SO₃⁻), fluorosulfonic acid ion (FSO₃⁻), toluenesulfonic acid ion, trinitrobenzenesulfonic acid ion, and trinitrotoluenesulfonic acid ion.

The onium salt, which can be used as the photo-cationic polymerization initiator, includes, for example, aromatic onium salts. Those preferably useable include, for example, aromatic halonium salt as described, for example, in Japanese Patent Application Laid-open No. 50-151996 corresponding to England Patent No. 1516351 and Japanese Patent Application Laid-open No. 50-158680 corresponding to U.S. Pat. No. 4,394,403; aromatic onium salt of the VIA group as described, for example, in Japanese Patent Application Laid-open No. 50-151997 corresponding to England Patent No. 1516511, Japanese Patent Application Laid-open No. 52-30899 corresponding to U.S. Pat. No. 4,256,828, Japanese Patent Application Laid-open No. 56-55420 corresponding to England Patent No. 2061280, and Japanese Patent Application Laid-open No. 55-125105 corresponding to U.S. Pat. No. 4,197,174; aromatic onium salt of the VA group as described, for example, in Japanese Patent Application Laid-open No. 50-158698 corresponding to U.S. Pat. No. 4,069,055; oxosulfoxonium salt as described, for example, in Japanese Patent Application Laid-open Nos. 56-8428, 56-149402, and 57-192429 corresponding to U.S. Pat. No. 4,387,216; aromatic diazonium salt as described, for example, in Japanese Patent Application Laid-open No. 49-17040; and thiopyrylium salt as described in U.S. Pat. No. 4,139,655. Those preferably useable also include, for example, initiators based on iron/allene complex and aluminum complex/photolysis silicon compound.

Commercially available products of the photo-cationic polymerization initiator are exemplified, for example, by those available under the trade names including, for example, UVI-6950, UVI-6970 (bis[4-(di(4-(2-hydroxyethyl)phenyl)sulfonio]-phenylsulfide), UVI-6974 (mixture of bis[4-diphenylsulfonio)-phenyl]sulfide bishexafluoroantimonate and diphenyl-4-thiophenoxyphenylsulfonium hexafluoroantimonate), and UVI-6990 (salt of hexafluorophosphate of UVI-6974) (all produced by Union Carbide Corporation); ADEKA Optomer SP-151, SP-170 (bis[4-(di(4-(2-hydroxyethyl)phenyl)sulfonio]-phenylsulfide), SP-150 (hexafluorophosphate of SP-170), and SP-171 (all produced by Asahi Denka Co., Ltd.); Irgacure 261 (η5-2,4-cyclopentadiene-1-yl)[(1,2,3,4,5,6-η)-(1-methylethyl)benzene]-iron(1+)-hexafluorophosphate(1−)) (produced by Ciba-Geigy Corporation); CI-2481, CI-2624, CI-2639, and CI-2064 (all produced by NIPPON SODA CO., LTD.); CD-1010, CD-1011, and CD-1012 (4-(2-hydroxytetradecanyloxy)diphenyliodonium hexafluoroantimonate) (all produced by Sartomer Company); DTS-102, DTS-103, NAT-103, NDS-103 ((4-hydroxynaphthyl)-dimethylsulfonium hexafluoroantimonate), TPS-102 (triphenylsulfonium hexafluorophosphate), TPS-103 (triphenylsulfonium hexafluoroantimonate), MDS-103 (4-methoxyphenyl-diphenylsulfonium hexafluoroantimonate), MPI-103 (4-methoxyphenyliodonium hexafluoroantimonate), BBI-101 (bis(4-tert-butylphenyl)iodonium tetrafluoroborate), BBI-102 (bis(4-tert-butylphenyl)iodonium hexafluorophosphate), and BBI-103 (bis(4-tert-phenyl)iodonium hexafluoroantimonate) (all produced by Midori Kagaku Co., Ltd.); and Degacure K126 (bis[4-(diphenylsulfonio)-phenyl]sulfide bishexafluorophosphate) (produced by Degussa). Among them, UVI-6970, UVI-6974, ADEKA Optomer SP-170, SP-171, CD-1012, and MPI-103 are preferably usable. However, there is no limitation to the illustratively exemplified compounds.

One of the photo-cationic polymerization initiators may be used singly, or two or more of the photo-cationic polymerization initiators may be used in combination.

Known compounds can be used for the pigment as the coloring agent without any special limitation. It goes without saying that it is possible to use, in a mixed manner, pigments including, for example, yellow pigments, orange pigments, red pigments, violet pigments, blue pigments, brown pigments, black pigments, and white pigments. In the case of the active energy beam-curable composition concerning the conventional technique, the adhesion performance is sometimes lowered when carbon black and/or copper phthalocyanine is used as the pigment. However, such an inconvenience is improved in the present invention as well.

Those used for the pigment dispersing agent include those in which the anchor is a base and which contain an active ingredient of the comb-shaped polymer that is liquid at room temperature.

The base to serve as the anchor is exemplified, for example, by primary amine salt, secondary amine salt, tertiary amine salt, and quaternary ammonium salt.

When the comb-shaped polymer, in which the anchor is a base and which is liquid at room temperature, is used as the active ingredient of the pigment dispersing agent, the adhesion performance is satisfactory even in the case of a base material such as polycarbonate on which it has been unsuccessful to obtain any satisfactory adhesion performance with the conventional active energy beam-curable composition.

The pigment dispersing agent may contain a solvent. However, the solvent may cause the out-gas in some cases. Therefore, it is not preferable to use the solvent in this viewpoint. Therefore, it is preferable that the pigment dispersing agent has a composition in which the active ingredient is 100%. When the active ingredient is 100%, it is possible to avoid the generation of the out-gas in a well-suited manner. Therefore, neither odor nor cloudiness appears.

A graft polymer is a preferred example of the comb-shaped polymer in which the anchor is the base and which is liquid at room temperature. Such a graft polymer has good pigment dispersion performance, because it has a lot of adhesion points or anchoring sites. Further, the adhesion performance is more improved on a hard-to-adhere base material such as polycarbonate, because such a graft polymer has a strong anchoring effect.

A graft polymer of poly(ethyleneimine)-poly(1,2-hydroxystearic acid) is a preferred example of the graft polymer (comb-shaped polymer in which the anchor is the base and which is liquid at room temperature). A commercially available product of such a graft polymer is Solsperse 28000 (trade name, produced by Avecia).

For example, the blending ratio of each of the components of the active energy beam-curable composition of the present invention may be appropriately established depending on the way of use and the method of use. However, the respective components are desirably blended in the following blending ratios. That is, it is assumed that the total amount of the epoxy compound and the oxetane compound is 100 parts by weight. On this assumption, the epoxy compound is 5 to 95 parts by weight, the oxetane compound is 5 to 95 parts by weight, the photo-cationic polymerization initiator is 0.5 to 12 parts by weight, and the pigment dispersing agent is not more than 20 parts by weight.

The ratio between the epoxy compound and the oxetane compound (total amount: 100 parts by weight) and the photo-cationic polymerization initiator may be changed depending on the type of the epoxy compound, the type of the oxetane compound, and the type of the photo-cationic polymerization initiator. However, the ratio is preferably within the range as described above.

On the other hand, if the amount of the pigment dispersing agent is too large, then the dispersion is destroyed, and the pigment is consequently coagulated and sedimented, which is not preferred. If the basic dispersing agent is excessively added to the cationic polymerization system, then the polymerization is inhibited, and the reaction velocity is consequently lowered. Therefore, the excessive addition is not preferred from this viewpoint as well. When the amount of the pigment dispersing agent is not more than 20 parts by weight as described above, the inconveniences as described above are not caused (or the inconveniences are substantially harmless, if any). Therefore, the preferred blending ratio of the pigment dispersing agent is not more than 20 parts by weight as described above.

The preferred blending ratio of the pigment dispersing agent is also restricted by the ratio with respect to the pigment. In other words, if the blending ratio of the pigment dispersing agent is too high with respect to the pigment, then the dispersion is destroyed, and the curing is consequently inhibited. The ratio between the both components is not uniform depending on, for example, the type of the pigment dispersing agent. However, when the pigment dispersing agent is blended in a weight ratio of not more than 2 with respect to a weight ratio of 1 of the pigment, neither destruction of the dispersion nor the inhibition of the curing is caused.

The active energy beam-curable composition of the present invention can be used, for example, for the coating and the printing (as an ink) in the same manner as the known active energy beam-curable compositions. Any arbitrary component, for example, a viscosity-adjusting agent may be added depending on the specified way of use. For example, when the active energy beam-curable composition of the present invention is used as an ink for an ink-jet printer, the viscosity may be adjusted to be not more than 30 mPa·s.

### Comparative Experiment 1

(1) Preparation of Compositions

The following components (A) to (E) were agitated and mixed in a dark room to produce inks (active energy beam-curable compositions) of Examples 1 and 2.

Component (A)

Epoxy compound: 3,4-epoxycyclohexylmethyl-3,4-epoxycyclohexane carboxylate [trade name: UVR-6110, produced by Union Carbide Corporation]: 30 parts by weight, limonene dioxide [produced by elfatochem]: 40 parts by weight.

Component (B)

Oxetane compound: di[ethyl(3-oxetanyl)]methyl ether [trade name: OXT-221, produced by Toagosei Co., Ltd.]: 40 parts by weight.

Component (C)

Photo-cationic polymerization initiator: mixture of hexafluorophosphate of triarylsulfonium and propylene carbonate [trade name: UVI-6990, produced by Union Carbide Corporation, diluted by 50% with propylene carbonate (active ingredient: 50%)]: 4 parts by weight.

Component (D)

Pigment: carbon black (Pigment Black 7) (Example 1) or copper phthalocyanine (Pigment Blue 15:3) (Example 2): 3 parts by weight.

Component (E)

Poly(ethyleneimine)-poly(1,2-hydroxystearic acid) graft polymer [trade name: Solsperse 28000, produced by Avecia]: 1.5 parts by weight.

Active energy beam-curable compositions of Comparative Examples 1 to 6, which were different from the compositions of Examples 1 and 2 in that the following compounds were used as the dispersing agent, were also produced (blending ratios of the respective components were the same as those of the compositions of Examples 1 and 2).

### COMPARATIVE EXAMPLE 1

Pigment: carbon black (Pigment Black 7);

Dispersing agent: Disperbyk 162 (produced by BYK Chemie), high molecular weight block copolymer having affinity to the pigment, active ingredient: 38%.

### COMPARATIVE EXAMPLE 2

Pigment: carbon black (Pigment Black 7);

Dispersing agent: Disparlon DA-703-50 (produced by Kusumoto Chemicals, Ltd.), amide amine salt of high molecular weight polyester acid, active ingredient: 50%.

### COMPARATIVE EXAMPLE 3

Pigment: copper phthalocyanine (Pigment Blue 15:3);

Dispersing agent: Disperbyk 162 (produced by BYK Chemie), high molecular weight block copolymer having affinity to the pigment, active ingredient: 38%.

### COMPARATIVE EXAMPLE 4

Pigment: copper phthalocyanine (Pigment Blue 15:3);

Dispersing agent: Disparlon DA-703-50 (produced by Kusumoto Chemicals, Ltd.), amide amine salt of high molecular weight polyester acid, active ingredient: 50%.

### COMPARATIVE EXAMPLE 5

Pigment: carbon black (Pigment Black 7);

Dispersing agent: Solsperse 32000 (produced by Avecia), comb-shaped polymer in which the anchor is a base and which is waxy at room temperature, active ingredient: 100%.

### COMPARATIVE EXAMPLE 6

Pigment: copper phthalocyanine (Pigment Blue 15:3);

Dispersing agent: Solsperse 32000 (produced by Avecia), comb-shaped polymer in which the anchor is a base and which is waxy at room temperature, active ingredient: 100%.

(2) Curing Method

Each of the compositions obtained as described above was applied to have a thickness of about 20 μm onto a polycarbonate plate, followed by being allowed to pass through once an ultraviolet-radiating apparatus (totalized quantity of light: 1000 mJ/cm²) of the conveyer type installed with a super high voltage mercury lamp of 120 W/cm so that the composition was cured.

Test machine: Eye Grandage ECS-401GX (lamp output: 3.0 kW) (produced by Eye Graphics Co., Ltd., belt conveyer type).

(3) Test by X-Cut Tape Method

An X-shaped blade cut (X-cut), which penetrated through the applied film formed on each of the specimens and which arrived at the base material surface, was caused with a cutter knife. A cellophane tape was stuck onto the X-cut, and the tape was peeled off therefrom to investigate the superiority or inferiority of the adhesion performance between the base material and the applied film or between the applied films (JIS K5400, Japanese Industrial Standards, Testing methods for paints). In this test, the state of exfoliation of the X-cut portion was visually observed to determine the evaluation score shown in the following table so that the score was used as an index to judge the superiority or inferiority of each of the specimens. When the specimen was composed of superimposed coating films, the evaluation was also made of the state of exfoliation between the applied films. Any exfoliation, which appeared at portions other than those specified in the “state of X-cut portion”, was not directed to the evaluation, but its state was recorded.

TABLE 1

| Evaluation | |
|---|---|
| score | State of X-cut portion |
| 10 | No exfoliation exists at all. |
| 8 | No exfoliation exists at point of intersection, |
| | but slight exfoliation exists at X-cut portion. |
| 6 | Exfoliation exists in any direction from point |
| | of intersection of X-cut portion within 1.5 mm. |
| 4 | Exfoliation exists in any direction from point |
| | of intersection of X-cut portion within 3.0 mm. |
| 2 | Almost all of X-cut portion stuck with tape |
| | undergoes exfoliation. |
| 0 | Exfoliation occurs over region larger than X- |
| | cut portion. |

(4) Cloudiness Test

The base material with the applied film was placed on a hot plate heated to 110° C., which was covered with a glass vessel disposed thereon to visually judge the cloudiness in the vessel after 24 hours.

+: no cloudiness is found at all;

±: cloudiness is slightly found;

−: cloudiness occurs conspicuously.

Results of the tests described above and other features are shown in Table 2.

TABLE 2

| | | | Total- | | | | | |
|---|---|---|---|---|---|---|---|---|
| | | | ized | | | | State | |
| | | Dispers- | light | X-cut | Cloud- | | at room | |
| | | ing | quantity | tape | iness | | temper- | Comb |
| | Pigment | agent | (mJ/cm²) | method | test | Anchor | ature | shape |
| Comp. | Pigment | Disper- | 1000 | 0 | ± | acid | liquid | − |
| Ex. 1 | Black 7 | byk 162 | | | | | | |
| Comp. | Pigment | DA-703- | 1000 | 0 | ± | base | liquid | − |
| Ex. 2 | Black 7 | 50 | | | | | | |
| Comp. | Pigment | Disper- | 1000 | 0 | ± | acid | liquid | − |
| Ex. 3 | Blue | byk 162 | | | | | | |
| | 15:3 | | | | | | | |
| Comp. | Pigment | DA-703- | 1000 | 0 | ± | base | liquid | − |
| Ex. 4 | Blue | 50 | | | | | | |
| | 15:3 | | | | | | | |
| Comp. | Pigment | Sols- | 1000 | 0 | + | base | waxy | + |
| Ex. 5 | Black 7 | perse | | | | | | |
| | | 3200 | | | | | | |
| Comp. | Pigment | Sols- | 1000 | 0 | + | base | waxy | + |
| Ex. 6 | Blue | perse | | | | | | |
| | 15:3 | 3200 | | | | | | |
| Example | Pigment | Sols- | 1000 | 10 | + | base | liquid | + |
| 1 | Black 7 | perse | | | | | | |
| | | 28000 | | | | | | |
| Example | Pigment | Sols- | 1000 | 8 | + | base | liquid | + |
| 2 | Blue | perse | | | | | | |
| | 15:3 | 28000 | | | | | | |

As shown in Table 2 above, Examples 1 and 2 exhibit good results in both of the test based on the X-cut tape method and the cloudiness test. That is, the adhesion performance is extremely satisfactory on the hard-to-adhere base material represented by polycarbonate, and the occurrence of the out-gas is not observed as well.

On the other hand, as clarified from the results of the test based on the X-cut tape method, Comparative Examples 1 to 6 are insufficient in adhesion performance on the hard-to-adhere base material. As for the cloudiness test, Comparative Examples 5 and 6 were satisfactory, but Comparative Examples 1 to 4 were unsatisfactory.

According to the results as described above, it is possible to confirm that the adhesion performance is extremely satisfactory and the out-gas is not generated as well, when the pigment dispersing agent, in which the anchor is the base and which contains the active ingredient of the comb-shaped polymer that is liquid at room temperature, is used.

### Comparative Experiment 2

Compositions, in which the same components (A) to (E) as those of the active energy beam-curable compositions of Examples 1 and 2 were used but the blending ratios of the components (A) to (C) were variously changed (pigment (D): carbon black (Pigment Black 7) was fixed to 3 parts by weight, and pigment dispersing agent (E): Solsperse 28000 (produced by Avevia) was fixed to 1.5 parts by weight), were prepare in the same manner as in “(1) Preparation of Compositions” in Comparative Experiment 1. The ultraviolet irradiation was performed in the same manner as in “(2) Curing method”, and the tests were performed in accordance with “(3) Test by X-cut Tape Method” and “(4) Cloudiness Test”. Obtained results are shown in Table 3.

TABLE 3

| Composition of ink | | | | Characteristic | |
|---|---|---|---|---|---|
| | (A) | | | values of applied | |
| (A) | Limonene | (B) | (C) | film | |
| UVR-6110 | dioxide | OXT-221 | UVI-6990 | X-cut | |
| (parts by | (parts by | (parts by | (parts by | tape | Cloudi- |
| weight) | weight) | weight) | weight) | method | ness test |
| 90 | 5 | 5 | 0.1 | uncured | |
| 60 | 20 | 20 | 0.1 | uncured | |
| 30 | 30 | 40 | 0.1 | uncured | |
| 10 | 20 | 70 | 0.1 | uncured | |
| 5 | 5 | 90 | 0.1 | uncured | |
| 5 | | 95 | 0.1 | uncured | |
| 90 | 5 | 5 | 0.5 | 10 | + |
| 60 | 20 | 20 | 0.5 | 10 | + |
| 30 | 30 | 40 | 0.5 | 10 | + |
| 10 | 20 | 70 | 0.5 | 10 | + |
| 5 | 5 | 90 | 0.5 | 10 | + |
| 5 | | 95 | 0.5 | 10 | + |
| 90 | 5 | 5 | 4 | 10 | + |
| 60 | 20 | 20 | 4 | 10 | + |
| 30 | 30 | 40 | 4 | 10 | + |
| 10 | 20 | 70 | 4 | 10 | + |
| 5 | 5 | 90 | 4 | 10 | + |
| 5 | | 95 | 4 | 10 | + |
| 90 | 5 | 5 | 10 | 10 | + |
| 60 | 20 | 20 | 10 | 10 | + |
| 30 | 30 | 40 | 10 | 10 | + |
| 10 | 20 | 70 | 10 | 10 | + |
| 5 | 5 | 90 | 10 | 10 | + |
| 5 | | 95 | 10 | 10 | + |
| 90 | 5 | 5 | 12 | 10 | + |
| 60 | 20 | 20 | 12 | 10 | + |
| 30 | 30 | 40 | 12 | 10 | + |
| 10 | 20 | 70 | 12 | 10 | + |
| 5 | 5 | 90 | 12 | 10 | + |
| 5 | | 95 | 12 | 10 | + |
| 90 | 5 | 5 | 15 | 8 | ± |
| 60 | 20 | 20 | 15 | 8 | ± |
| 30 | 30 | 40 | 15 | 8 | ± |
| 10 | 20 | 70 | 15 | 8 | ± |
| 5 | 5 | 90 | 15 | 8 | ± |
| 5 | | 95 | 15 | 8 | ± |

According to the results of Comparative Experiment 2, on condition that the total amount of the epoxy compound and the oxetane compound is 100 parts by weight, it is appreciated that no problem arises when each of the epoxy compound and the oxetane compound is within a range of 5 to 95 parts by weight.

If the amount of the photo-cationic polymerization initiator is too small, no curing occurs, because the acid as the polymerization-initiating species is generated in an excessively small amount. If the amount of the photo-cationic polymerization initiator is 15 parts by weight, then the grades of the X-cut tape method and the cloudiness test are lowered to some extent, because the dilution solvent in the photo-cationic polymerization initiator remains after the curing of the applied film, and it behaves as the out-gas component to cause the cloudiness. Therefore, it can be confirmed that the photo-cationic polymerization initiator is desirably blended within a range of 0.5 to 15 parts by weight and preferably within a range of 0.5 to 12 parts by weight, when the total amount of the epoxy compound and the oxetane compound is 100 parts by weight.

When an experiment was performed separately, the following fact was successfully confirmed. That is, when the total amount of the epoxy compound and the oxetane compound is 100 parts by weight, if the pigment dispersing agent exceeds 20 parts by weight, then the dispersion is destroyed due to the presence of the base, and the pigment is consequently coagulated and sedimented. When the basic pigment dispersing agent is restricted to be not more than 20 parts by weight, no inhibition of polymerization was caused as well.

In relation to the blending ratio between the pigment and the pigment dispersing agent, it has been successfully confirmed that neither destruction of the dispersion nor inhibition of the polymerization occurs provided that the pigment dispersing agent is blended in a weight ratio of not more than 2 with respect to a weight ratio of 1 of the pigment.

According to the results described above, the following fact is affirmed for the active energy beam-curable composition of the present invention. That is, on condition that the total amount of the epoxy compound and the oxetane compound is 100 parts by weight, it is desirable that the epoxy compound is blended by 5 to 95 parts by weight, the oxetane compound is blended by 5 to 95 parts by weight, the photo-cationic polymerization initiator is blended by 0.5 to 12 parts by weight, and the pigment dispersing agent is blended by not more than 20 parts by weight. Further, it is more desirable that the pigment dispersing agent is blended in a weight ratio of not more than 2 with respect to a weight ratio of 1 of the pigment.

Various substances and numerical values have been illustratively exemplified in the embodiments (including Examples) of the present invention, but they are examples in every sense. The present invention is not limited thereto. It goes without saying that the present invention can be carried out in other various forms within a range without deviating from the gist or essential characteristics of the present invention.

When the active energy beam-curable composition of the present invention is used as an ink for ink-jet printing, the active energy beam-curable composition may contain, for example, a coloring agent such as a synthetic dye or a pigment, an inorganic filler, a surface-treating agent (a surfactant and/or a dispersing agent), a viscosity-adjusting agent, a treating agent, and an ultraviolet radiation-blocking agent, in addition to the photo-cationic polymerizable substance, the photo-cationic polymerization initiator, the oxetane compound and the pigment dispersing agent. When the composition is used as an ink for ink-jet application, the composition is prepared so that the viscosity of the composition upon discharging the ink from an ink jet head is 2 cps to 30 cps. U.S. Pat. No. 5,059,266 discloses, for example, additives, contents thereof, and characteristics of the ink when the active energy beam-curable composition is used as an ink for ink-jet printing. The disclosure of this U.S. patent has been incorporated herein by reference. The active energy beam, which is used to cure the composition of the present invention, includes, ultraviolet radiation, infrared radiation, and electron beam (EB).

As explained above, the active energy beam-curable composition of the present invention comprises the epoxy compound, the oxetane compound, the photo-cationic polymerization initiator, the pigment as the coloring agent, and the pigment dispersing agent, wherein the pigment dispersing agent contains the active ingredient of the comb-shaped polymer in which the anchor is the base and which is liquid at room temperature. Therefore, the adhesion performance is satisfactory even in the case of the base material such as polycarbonate on which it has been impossible to obtain any satisfactory adhesion performance with the conventional active energy beam-curable composition.

What is claimed is:

1. An active energy beam-curable composition comprising an epoxy compound (A), an oxetane compound (B), a photo-cationic polymerization initiator (C), a pigment (D) as a coloring agent, and a pigment dispersing agent (E), wherein:
the pigment dispersing agent (E) contains a comb-shaped polymer in which an anchor is a base and which is liquid at room temperature.

2. The active energy beam-curable composition according to claim 1, wherein the pigment dispersing agent (E) consists of the comb-shaped polymer.

3. The active energy beam-curable composition according to claim 1, wherein the comb-shaped polymer is a graft polymer.

4. The active energy beam-curable composition according to claim 1, wherein the comb-shaped polymer is a graft polymer, and the graft polymer is a graft polymer of poly(ethyleneimine)-poly(1,2-hydroxystearic acid).

5. The active energy beam-curable composition according to claim 1, wherein the epoxy compound (A) is blended in an amount of 5 to 95 parts by weight, the oxetane compound (B) is blended in an amount of 5 to 95 parts by weight, the photo-cationic polymerization initiator (C) is blended in an amount of 0.5 to 12 parts by weight, and the pigment dispersing agent (E) is blended in an amount of not more than 20 parts by weight, provided that a total amount of the epoxy compound (A) and the oxetane compound (B) is 100 parts by weight.

6. The active energy beam-curable composition according to claim 1, wherein the pigment dispersing agent (E) is blended such that a weight ratio of the dispersing agent to the pigment (D) is not more than 2.
